(19) United States
(12) Patent Application Publication
(10) Pub. No.: US 2008/0067901 A1
(43) Pub. Date: Mar. 20, 2008

(54) Pivoting Drawer Face

(76) Inventor: Derek Chen, San Francisco, CA (US)

Correspondence Address: PATENT LAW OFFICES OF MICHAEL E. WOODS, 3433 WHEELING DRIVE, SANTA CLARA, CA, 95051, US

(21) Appl. No.: 11/745,208

(22) Filed: May 7, 2007

Related U.S. Application Data
(60) Provisional application No. 60/767,515, filed on May 9, 2006.

(51) Int. Cl. E06B 3/50

(52) U.S. Cl. 312/109

(57) ABSTRACT

An apparatus, system, and method for providing an opening solution for drawers and similar enclosure systems that permit no visible external hardware or gripping elements/surfaces that may be easily used irrespective of a size or weight of the drawer or enclosure. An apparatus includes a housing including an exterior wall having a portion defining an opening; a drawer translatably mounted within the housing, the drawer moveable between a closed position wherein a storage space within the drawer is inaccessible from outside the housing, and an open position wherein the drawer extends out of the housing through the opening such that the storage space is accessible, the drawer including a drawer face moveably coupled to a drawer body including the storage space with the drawer face free of any externally accessible handle when the drawer is in the closed position, the drawer face having a perimeter conforming closely to a perimeter of the opening of the housing when the drawer is in the closed position, wherein the drawer face includes an edge exposing mode and an edge concealing mode with the edge concealing mode providing the drawer face flush with the portion of the exterior wall in the closed mode with no gripping surface to extend the drawer from the closed mode to the open and wherein the edge exposing mode pivoting the drawer face so it is not flush with the portion of the exterior wall and exposes an edge of the face in the closed mode for use in extending the drawer from the closed mode to the open mode.

### BACKGROUND OF THE INVENTION

The present invention relates generally to furniture, and more specifically to a mechanism and process for one or more inset drawers having a stealth opening system and method.

There are many different types of furniture categories and furniture designs for each category and sub-category, many having different constructions to achieve a desired element or function. A common element in these constructions is one or more drawers. A typical drawer includes as is well-known a drawer body defining an enclosure with an open top that translates, via runners, guides, slides, rollers, rails and the like, relative to a housing (sometimes referred to as a carcass). The drawer body repeatedly translates (either sliding or rolling or other mechanism) into and out of the housing through an opening—either an individual opening sized specifically for one drawer or through an opening sized for multiple adjacent drawers. As is also well-known, the drawer body is usually provided with a drawer face for cosmetic economic reasons.

Cosmetically, the drawer face hides operating hardware or gaps or tolerances used during the construction. Additionally, the drawer face may provide other artistic element to the furniture. The drawer face may be constructed of a more expensive material or made with a more expensive process than the drawer body construction, yet provide an impression that the entire drawer has the desired attribute.

A piece of furniture, particularly a set of drawers, often includes a face frame that defines the opening or openings through which the drawer body or bodies extend and retract. When a drawer having a drawer body and a drawer face is closed, the drawer face may either abut the face frame and overlie and cover the opening through which the drawer body extends and retracts (e.g., the drawer face is larger than the opening in the face frame) or the drawer face is designed to be inset into the face frame. The same idea applies to adjacent drawers that extend and retract through a common opening, when retracted the drawer faces of the adjacent drawers closely conform and provide a very small gap between the drawer faces.

In any case, it is important to a user to be able to extend a drawer from the retracted position, which is especially hard for an inset drawer, and even more so for an inset drawer having tight tolerances. A common solution is to provide externally accessible hardware or handgrips or other surfaces that may be used to extend a completely retracted drawer.

Because of an extreme diversity of furniture designs and construction methods, it is sometimes desirable to provide alternatives to these externally accessible elements as they are often visible and may interfere with the furniture designers vision of the piece, or of the preferences of the user.

Therefore, the prior art has provided non-visible extending mechanisms for drawers. A common solution that is acceptable in some situations (e.g., small and/or light-weight drawers) is use of a spring-loaded mounting system that permits a user to press inward on a drawer face which triggers the mechanism and automatically extends the drawer sufficiently that an edge or other design element is exposed that the user is able to grip or otherwise manipulate to thereafter completely extend the drawer. This has the advantage of hiding the extending mechanism but it is impractical or unsuitable for larger or heavier drawers.

Therefore what is needed is an apparatus, system, and method for providing an opening solution for drawers and similar enclosure systems that permit no visible external hardware or gripping elements/surfaces that may be easily used irrespective of a size or weight of the drawer or enclosure.

### BRIEF SUMMARY OF THE INVENTION

Disclosed is an apparatus, system, and method for providing an opening solution for drawers and similar enclosure systems that permit no visible external hardware or gripping elements/surfaces that may be easily used irrespective of a size or weight of the drawer or enclosure. An apparatus includes a housing including an exterior wall having a portion defining an opening; a drawer translatably mounted within the housing, the drawer moveable between a closed position wherein a storage space within the drawer is inaccessible from outside the housing, and an open position wherein the drawer extends out of the housing through the opening such that the storage space is accessible, the drawer including a drawer face moveably coupled to a drawer body including the storage space with the drawer face free of any externally accessible handle when the drawer is in the closed position, the drawer face having a perimeter conforming closely to a perimeter of the opening of the housing when the drawer is in the closed position, wherein the drawer face includes an edge exposing mode and an edge concealing mode with the edge concealing mode providing the drawer face flush with the portion of the exterior wall in the closed mode with no gripping surface to extend the drawer from the closed mode to the open and wherein the edge exposing mode pivoting the drawer face so it is not flush with the portion of the exterior wall and exposes an edge of the face in the closed mode for use in extending the drawer from the closed mode to the open mode.

A method includes a) disposing a drawer into an opening in a structure wherein a drawer face generally conforms to the opening and the drawer face is free from any visible gripping surface, the drawer translatably mounted within the structure, the drawer moveable between a closed position wherein a storage space within the drawer is inaccessible from outside the housing, and an open position wherein the drawer extends out of the structure through the opening such that the storage space is accessible, the drawer including a drawer face moveably coupled to a drawer body including the storage space with the drawer face free of any externally accessible handle when the drawer is in the closed position, wherein the drawer face an edge exposing mode and an edge concealing mode with the edge concealing mode providing the drawer face flush with the opening, the drawer face moving relative to the drawer body when transitioning from one mode to the other; b) transitioning the drawer face from the edge concealing mode to the edge exposing mode; and c) extending the drawer by gripping an edge of the drawer face exposed by the edge exposing mode.

Providing for a multi-mode face panel as described and suggested herein such that no visible external gripping surfaces are required improves options available to designers and users. The present invention may be adapted to enclosure types other than drawers and permits adaptation for differing sizes, capacities, and weights of the enclosure.

### BRIEF DESCRIPTION OF THE DRAWINGS

FIG. 1 is a front elevation view of a cabinet including a box and three inset drawers;

FIG. 2 is a front elevation view of the three-drawer cabinet, with the middle drawer front pivoted so that it can be grasped by the bottom edge;

FIG. 3 is a front elevation view of the three-drawer cabinet, with the drawer shown pulled open;

FIG. 4 is a cutaway side view of a drawer arrangement such as shown, for example, in FIG. 1 through FIG. 3;

FIG. 5 is a side view of the arrangement shown in FIG. 4 with a middle drawer 505 transitioned to the edge-exposing mode, with a drawer face of the middle drawer pivoted to provide access to the bottom edge; and

FIG. 6 is a cutaway side view of an alternate drawer arrangement having a box and three vertically stacked drawers, each drawer having a drawer face moveably coupled to a drawer body.

### DETAILED DESCRIPTION OF THE INVENTION

The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

FIG. 1 is a front elevation view of a cabinet 100 including a box 105 and three inset drawers 110. Drawers 110 each have a drawer face that fronts each drawer 110 and sits entirely within box 105 (or a face frame or the like), with no handle or edge available to be grasped. Other variations are possible, such as non-inset drawers or partially inset drawers. The present invention may be applied to systems other than only drawer cabinets, including single drawer solutions and other similar enclosures, whether extending and retracting through a single opening in box 105 or solutions in which each enclosure extends and retracts through an individual opening in box 105.

A distinguishing feature of the preferred embodiment of the present invention shown in FIG. 1 through FIG. 5 is that the enclosure can be free of any externally visible handholds or gripping surfaces when drawer 110 is retracted completely within box 105. Normally, without the present invention, an extension of any single drawer 110 out of box 105 would be difficult if not impossible for an unequipped hand, particularly when all other drawers 110 are retracted completely. The present invention makes such extensions simple and efficient.

For the following discussion, the term “inset” includes the condition that the drawer face of a drawer implementing the present invention is constructed and oriented in such fashion that most (if not all) of the lateral edges of the drawer face are covered or concealed by box 105, a face frame, other adjacent drawer faces, or other element or elements of cabinet 100 to prevent a user from obtaining enough purchase using the unaided hand to grip and extract the drawer. A drawer face in this inset condition is referred to as being in an edge-concealing mode.

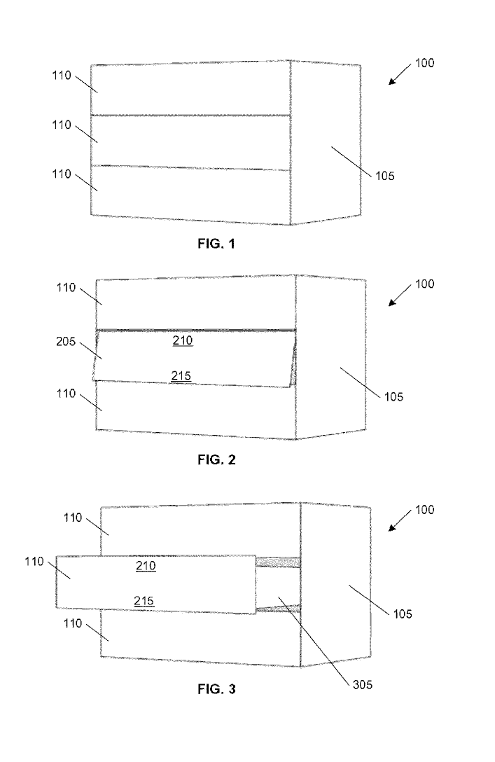

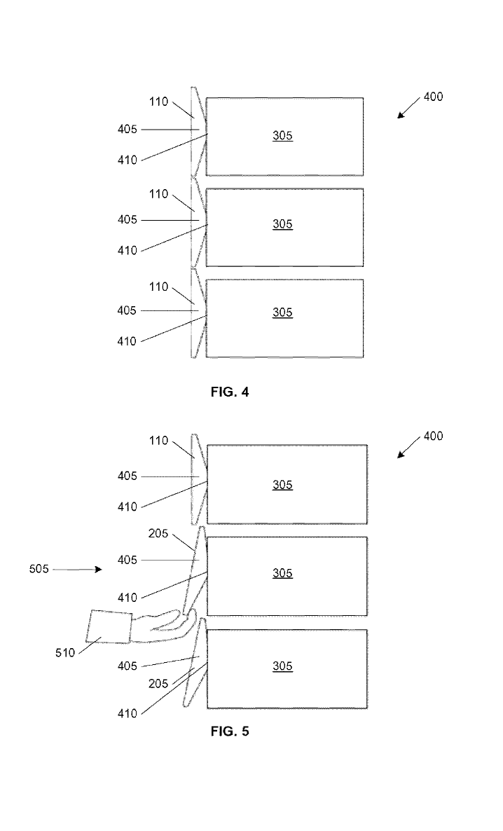

FIG. 2 is a front elevation view of cabinet 100, with a middle drawer front 205 pivoted to transition from the edge-concealing mode shown in FIG. 1 to an edge-exposing mode (in this case exposing a bottom edge of middle drawer 110) permitting the exposed edge to be used as a gripping surface. Alternatively in some implementations, the edge exposing mode may expose a gripping surface disposed near the exposed edge. Transition of middle drawer 110 from the edge-concealing mode shown in FIG. 1 to the edge-exposing mode shown in FIG. 2 may be achieved in many different ways—for example by pressing on a portion of the drawer face that is on an opposite side of a fulcrum or pivot axis from the edge to be exposed. Further details of this operation are explained herein, including in the discussion of FIG. 4 and FIG. 5 below. At this point, one important point to emphasize is that a user presses in on a portion of the drawer face to move the drawer face relative to a drawer box to which it is attached which then controls the drawer face mode. In this particular example, a user presses along a top half of middle drawer 110 (e.g., at a portion 210 of face 205) to “tilt” drawer face 205 and expose an edge along the bottom half (e.g., at a portion 215 of face 205).

FIG. 3 is a front elevation view of cabinet 100, with the middle drawer 110 shown pulled open to expose a drawer body 305. The middle drawer was extended from box 105 using, at least partially, bottom edge portion 215. This is noted as at least partially because after drawer 110 is extended sufficiently from box 105, there are many other edges and gripping surfaces that become may become exposed to further facilitate full extension of drawer 110 from box 105. Traditionally, drawer body 305 is mounted within box 105 to permit drawer 110 to extend out of box 105 and to retract into box 105. The mounting may include guides, rails, rollers and other designs.

FIG. 4 is a cutaway side view of a drawer arrangement 400 such as shown, for example, in FIG. 1 through FIG. 3. Each drawer 110 includes drawer body 305 and a drawer face 405 moveably coupled to drawer body 305. In the preferred embodiment, the moveably coupling includes a fulcrum 410 about which drawer face 405 pivots relative to drawer body 305. For ease of visualization and explanation, fulcrum 410 is shown as a single coupling near a centerline of drawer face 405 which permits drawer face 405 to pivot equally easily upwardly or downwardly (also described as counterclockwise or clockwise, respectively, in the depiction of FIG. 4). In some embodiments, fulcrum 410 may be displaced from the centerline which predominates one edge over another. For example, moving fulcrum 410 upwards from the centerline predominates the bottom edge. In an extreme case, a particular drawer face may be moveable in one direction only to expose a single edge instead of dual opposite edges as shown in arrangement 400.

It is not required that fulcrum 410 be a single point (axial) of attachment or a pivot point in the strictest sense as the coupling between a drawer face and its associated drawer body may include a mechanical assembly defining a virtual fulcrum defining a pivot axis or a pivot path about which a drawer face moves when transitioning from the edge-concealing mode to the edge-exposing mode. Further, it is not required that the fulcrum axis lie along a horizontal axis as shown and described in FIG. 1 through FIG. 4. In some embodiments, the fulcrum axis may be vertical with lateral (e.g., left-hand side and right-hand side) edges of a drawer face exposable by using a modification of the disclosed embodiments. That is, rather than FIG. 4 representing a side view, it could represent a top/bottom view for three drawers laterally disposed to one another.

FIG. 5 is a side view of arrangement 400 shown in FIG. 4 with a middle drawer 505 transitioned to the edge-exposing mode, with drawer face 405 of middle drawer 505 pivoted to provide access to the bottom edge. In this representation, the bottom drawer face also pivots to provide more room for the fingers of a hand 510 of the user when gripping the exposed bottom edge. In this position, hand 510 may now extend drawer 505 from the cabinet, even though drawer 505 is free from any visible or accessible gripping surfaces when it is retracted completely into the cabinet.

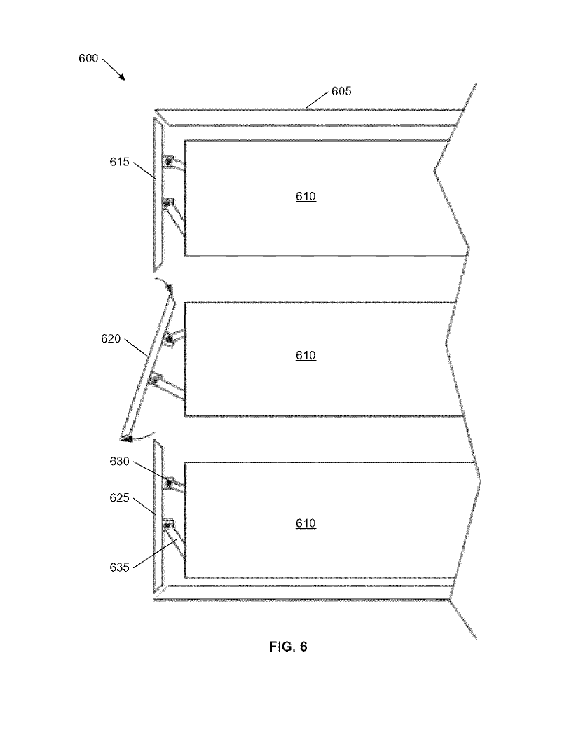

FIG. 6 is a cutaway side view of an alternate drawer arrangement 600 having a box 605 and three vertically stacked drawers, each drawer having a drawer face moveably coupled to a drawer body 610. The top drawer includes a drawer face 615, the middle drawer includes a drawer face 620, and the bottom drawer includes a drawer face 625. Each drawer face is mechanically associated with its drawer body 610 by two pairs of arms (a first pair 630 and a second pair 635). In this implementation, the drawer faces pivot on a horizontal access on four arms (e.g., an arm at or near each “corner” of a drawer face), allowing the drawer face to swing clear of any potential obstructions, either from an edge of box 605 or from any adjacent drawers. Each pair of arm defines a coupling and movement arc to translate and rotate a drawer face as desired when transitioning from the edge-concealing mode (e.g., drawer face 615 and drawer face 625) to the edge-exposing mode (e.g., drawer face 620). Other arrangements of the arms, and other numbers of arms are all permitted and anticipated when implementing the present invention using this second alternate drawer arrangement.

The discussion herein has been made relating to “standard” drawers having horizontal and vertical components or features and the like. The present invention is also easily adaptable to drawers having a rotation from the horizontal/vertical, such as for example a drawer rotated forty-five degrees. Horizontal and vertical are described as most drawers have this orientation and it is convenient to refer to this relationship. However, other orientations are possible and are contemplated to be within the scope of the present invention.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. An apparatus, comprising:
a housing including an exterior wall having a portion defining an opening;
a drawer translatably mounted within said housing, said drawer moveable between a closed position wherein a storage space within said drawer is inaccessible from outside said housing, and an open position wherein said drawer extends out of said housing through said opening such that said storage space is accessible, said drawer including a drawer face moveably coupled to a drawer body including said storage space with said drawer face free of any externally accessible handle when said drawer is in said closed position, said drawer face having a perimeter conforming closely to a perimeter of said opening of said housing when said drawer is in said closed position, wherein said drawer face includes an edge exposing mode and an edge concealing mode with said edge concealing mode providing said drawer face flush with said portion of said exterior wall in said closed mode with no gripping surface to extend said drawer from said closed mode to said open and wherein said edge exposing mode pivoting said drawer face so it is not flush with said portion of said exterior wall and exposes an edge of said face in said closed mode for use in extending said drawer from said closed mode to said open mode.

2. The apparatus of claim 1 wherein said drawer face moveable couple includes a fixed single fulcrum.

3. The apparatus of claim 2 wherein said fulcrum is coupled near a centerline of said drawer face to alternatively expose one of a first edge and a second edge opposite to said first edge.

4. The apparatus of claim 3 wherein said first edge is a bottom edge and said second edge is a top edge.

5. The apparatus of claim 3 wherein said first edge is a left-hand edge and said second edge is a right-hand edge.

6. The apparatus of claim 1 wherein said moveable coupling includes a mechanical assembly cooperating to concurrently pivot and translate said drawer face relative to said drawer body in said closed mode when transitioning said drawer face from said edge concealing mode to said edge exposing mode.

7. The apparatus of claim 6 wherein said mechanical assembly includes a first pair of first arms and a second pair of second arms.

8. The apparatus of claim 7 wherein said edge exposing mode exposes a particular one edge of said drawer face with said first pair of arms disposed further from said particular one edge and shorter than said second pair of arms.

9. The apparatus of claim 7 wherein said first pair of arms and second pair of arms are adapted to provide coupling positions between said drawer face and said drawer body that produce non-parallel arcs to translate and pivot said drawer face when transitioning from said concealed mode to said exposed mode.

10. The apparatus of claim 2 wherein said fulcrum is coupled to said drawer face and displaced from a centerline of said drawer face to predominately expose one of a first edge of a drawer face and a second edge of said drawer face opposite to said first edge.

11. The apparatus of claim 10 wherein only said predominate one drawer face edge is exposable upon a pivoting of said drawer face about said fulcrum.

12. An apparatus, comprising:
a housing including an exterior wall having a portion defining an opening;
one or more drawers each translatably mounted within said housing, each particular said drawer moveable between a closed position wherein a storage space within said particular drawer is inaccessible from outside said housing, and an open position wherein said particular drawer extends out of said housing through an area of said opening such that said storage space is accessible, said particular drawer including a drawer face moveably coupled to a drawer body including said storage space with said drawer face free of any externally accessible handle when said particular drawer is in said closed position, said drawer face having a perimeter conforming closely to a perimeter of said area of said opening of said housing when said drawer is in said closed position, wherein said area is defined by any adjacent drawer faces of contiguous drawers of said one or more drawers also extendable from said opening wherein said drawer face includes an edge exposing mode and an edge concealing mode with said edge concealing mode providing said drawer face flush with said portion of said exterior wall and any adjacent drawer faces in said closed mode with no gripping surface to extend said particular drawer from said closed mode to said open and wherein said edge exposing mode pivoting said drawer face so it not flush with said portion of said exterior wall and any adjacent drawer faces in said closed mode for use in extending said drawer from said closed mode to said open mode.

13. The apparatus of claim 12 wherein said drawer face moveable coupling includes a fixed single fulcrum.

14. The apparatus of claim 13 wherein said fulcrum is coupled near a centerline of said drawer face to alternatively expose one of a first edge and a second edge opposite to said first edge.

15. The apparatus of claim 14 wherein said first edge is a bottom edge and said second edge is a top edge.

16. The apparatus of claim 14 wherein said first edge is a left-hand edge and said second edge is a right-hand edge.

17. The apparatus of claim 12 wherein said moveable coupling includes a mechanical assembly cooperating to concurrently pivot and translate said drawer face relative to said drawer body in said closed mode when transitioning said drawer face from said edge concealing mode to said edge exposing mode.

18. The apparatus of claim 17 wherein said mechanical assembly includes a first pair of first arms and a second pair of second arms.

19. The apparatus of claim 18 wherein said first pair of arms and second pair of arms are adapted to provide coupling positions between said drawer face and said drawer body that produce non-parallel arcs to translate and pivot said drawer face when transitioning from said concealed mode to said exposed mode.

20. The apparatus of claim 13 wherein said fulcrum is coupled to said drawer face and displaced from a centerline of said drawer face to predominately expose one of a first edge of a drawer face and a second edge of said drawer face opposite to said first edge.

21. The apparatus of claim 20 wherein only said predominate one drawer face edge is exposable upon a pivoting of said drawer face about said fulcrum.

22. A method, the method comprising:
a) disposing a drawer into an opening in a structure wherein a drawer face generally conforms to said opening and said drawer face is free from any visible gripping surface, said drawer translatably mounted within said structure, said drawer moveable between a closed position wherein a storage space within said drawer is inaccessible from outside said housing, and an open position wherein said drawer extends out of said structure through said opening such that said storage space is accessible, said drawer including a drawer face moveably coupled to a drawer body including said storage space with said drawer face free of any externally accessible handle when said drawer is in said closed position, wherein said drawer face an edge exposing mode and an edge concealing mode with said edge concealing mode providing said drawer face flush with said opening, said drawer face moving relative to said drawer body when transitioning from one mode to the other;
b) transitioning said drawer face from said edge concealing mode to said edge exposing mode; and
c) extending said drawer by gripping an edge of said drawer face exposed by said edge exposing mode.

23. A method, the method comprising:
a) transitioning a drawer face moveably coupled to a drawer body translatably mounted in a housing from a grip concealing mode to a grip exposing mode, said drawer face free of an externally accessible gripping surface when in said edge concealing mode and said drawer face, when said drawer body is in a closed mode, conforming closing to elements adjacent to an opening through which said drawer body extends when moving from said closed mode in which a storage space of said drawer body is inaccessible to an open mode exposing said storage space, said drawer face moving relative to said drawer body when transitioning from one mode to the other; and thereafter;
b) transitioning said drawer body from said closed mode to said open mode using a gripping surface exposed by said grip exposing mode wherein said gripping surface is inaccessible when said drawer body is in said closed mode and said drawer face is in said grip concealing mode.
